(19) United States
(12) Patent Application Publication
(10) Pub. No.: US 2005/0212228 A1
(43) Pub. Date: Sep. 29, 2005

(54) Adaptable recreational sliding platform

(76) Inventor: Shannon Best, Delray Beach, FL (US)

Correspondence Address: Mark D. Bowen;Stearns Weaver Miller, et al., Suite 1900, 200 East Broward Boulevard, Fort Lauderdale, FL, 33301, US

(21) Appl. No.: 11/078,260

(22) Filed: Mar. 11, 2005

Related U.S. Application Data
(60) Provisional application No. 60/552,243, filed on Mar. 11, 2004.

(51) Int. Cl. B62B 15/00

(52) U.S. Cl. 280/14.21

(57) ABSTRACT

Sliding platforms for recreational and competitive sport use are adaptable to different shapes, thereby accommodating more than one style, rider shape, weather condition, desired performance characteristic, or the like. An adaptable sliding platform according to the present invention includes a base or main body section having ends adapted for attachment to modular ends of differing size, shape, or performance configuration. In an alternate embodiment, an adaptable sliding platform has a base section wherein the sides are adapted for attachment of modular side of differing size, shape, or performance configuration. The present invention thus provides recreational sliding platforms, such as kite boards, wake boards, surfboards, skis and the like, adaptable to different shapes, thereby accommodating more than one style, rider shape, desired performance characteristic, or riding condition.

### CROSS REFERENCE TO RELATED APPLICATIONS

This application claims the benefit of U.S. Provisional Patent Application Ser. No. 60/552,243, filed Mar. 11, 2004.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

The present invention relates to sliding platforms used in recreational activities, such as wakeboards, surfboards, skis and the like. More particularly, the present invention relates to adaptable sliding platforms wherein modular sections may be user modified to alter the size, shape, or performance characteristics.

2. Description of Related Art

The recreational industry is currently developing a wide variety of shapes and sizes for platforms usable to assist riders who generally slide on or through a medium, such as snow or water. Examples of the platforms include kite boards, wake boards, knee boards, surfboards, body or boogie boards, skim boards, skurf boards, water skis, snow skis, snowboards, combinations of the foregoing, or the like.

Because even small variations in shape and length can cause often dramatic differences in the performances or response of a particular platform, manufacturers and retailers offer consumers a dizzying array of different size, shape, or fin combinations alleged to be adapted for any one or combination of body shapes, riding styles, performance characteristics, weather conditions, or the like. Riders of sliding platforms often purchase multiple platforms so as to insure that they have a board that is suited for the riding conditions on any given day. In addition, since riding conditions can rapidly change, riders often transport multiple platforms to the riding location. The need to purchase and transport multiple sliding platforms is a significant disadvantage and has limited the growth of certain sliding sports. Accordingly, there exists a need for a recreational sliding platform that is adaptable to accommodate more than one style, rider shape, weather condition, desired performance characteristic, or the like.

### BRIEF SUMMARY OF THE INVENTION

The present invention overcomes the disadvantages in the art by providing platforms for recreational use that are adaptable to different shapes, thereby accommodating more than one style, rider shape, weather condition, desired performance characteristic, or the like. An adaptable sliding platform according to the present invention includes a base or main body section having ends adapted for attachment to modular ends of differing size, shape, or performance configuration. In an alternate embodiment, an adaptable sliding platform has a base section wherein the sides are adapted for attachment of modular side of differing size, shape, or performance configuration. In yet another alternate embodiment the present invention contemplates an adaptable sliding platform formed from attachment of interchangeable first and second platform components, such as a front half and a rear half. The present invention thus provides recreational sliding platforms, such as kite boards, wake boards, surfboards, skis and the like, adaptable to different shapes, thereby accommodating more than one style, rider shape, desired performance characteristic, or riding condition.

Accordingly it is an object of the present invention to provide an improved recreational and competitive sliding platform.

Another object of the present invention is to provide a sliding platform that is adaptable.

Yet another object of the present invention is to a sliding platform having adaptable configurations.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1A illustrates a kiteboard or wakeboard in accordance with the prior art;

FIGS. 1B-1E illustrate a kiteboard or wakeboard with adaptable ends in accordance with the present invention;

FIG. 2A illustrates a body board in accordance with the prior art;

FIGS. 2B-2E illustrate a body board with adaptable tail ends in accordance with the present invention;

FIG. 3A illustrates a water ski in accordance with the prior art;

FIGS. 3B-3E illustrate a water ski with adaptable tail ends in accordance with the present invention;

FIG. 4A illustrates a snowboard in accordance with the prior art;

FIGS. 4B-4E illustrate a snowboard with adaptable ends in accordance with the present invention;

FIG. 5A illustrates a skateboard in accordance with the prior art;

FIGS. 5B-5E illustrate a skateboard with adaptable ends in accordance with the present invention;

FIG. 6A illustrates a surfboard in accordance with the prior art; and

FIGS. 6B-6E illustrate a surfboard having adaptable tail ends in accordance with the present invention.

### DETAILED DESCRIPTION OF THE INVENTION

Aspects of the present invention include a riding platform, such as the platforms discussed in the Background herein, that is adaptable to change its shape, length, or performance characteristics. Such adaptation can include one or more of changing the platform's length, width, thickness, shape, rails, edges, nose, tail, center section, or any one or more portions thereof. Such adaptation provides for a small number of more expensive platforms or “boards” (such as even just one) to be adaptable to different desired shapes. In exemplary embodiments described herein, the adaptation may include the combination of other less expensive portions or components with the more expensive board section to create a configuration toward a desired shape. For example, tail or nose sections may be combined with the board to configure a desired shape.

In one embodiment, the interchangeable sections can include, but are not limited to, sections that configure the board to resemble traditional shapes of any of those boards listed above. These may include triangular sections, trapezoidal sections, square sections, rectangular sections, semi-circular sections, semi-ovular sections, rounded sections, single-tipped sections, double-tipped sections, semi-ovular sections, rounded sections, single-tipped sections, double-tipped sections, multi-tipped sections, sections of narrowing width, sections of narrowing depth, sections of expanding width, sections of expanding depth, sections whose depth changes only on one side, sections who edges narrow in one or more incremental steps, sections with rounded edges, sections with sharp edges, sections whose leading edge has one or more points attached thereto, sections with one or more friction enhancing surfaces, sections with slick surfaces, sections with one or more fins, sections that combine one or more of the aspects listed, or not listed, herein, or the like.

According to an embodiment, the interchangeable sections can be connected to the platform by any means known to those of skill in the art from the disclosure herein. For example, the combinations may include removable bolts, nuts, screws, pegs, rods, interlocking sections, suction or friction-fit pieces, tabs, hinges, glues, resins, epoxies, shims, hook and loop style fasteners such as Velcro®, fasteners, any combination of connection thereof, or the like.

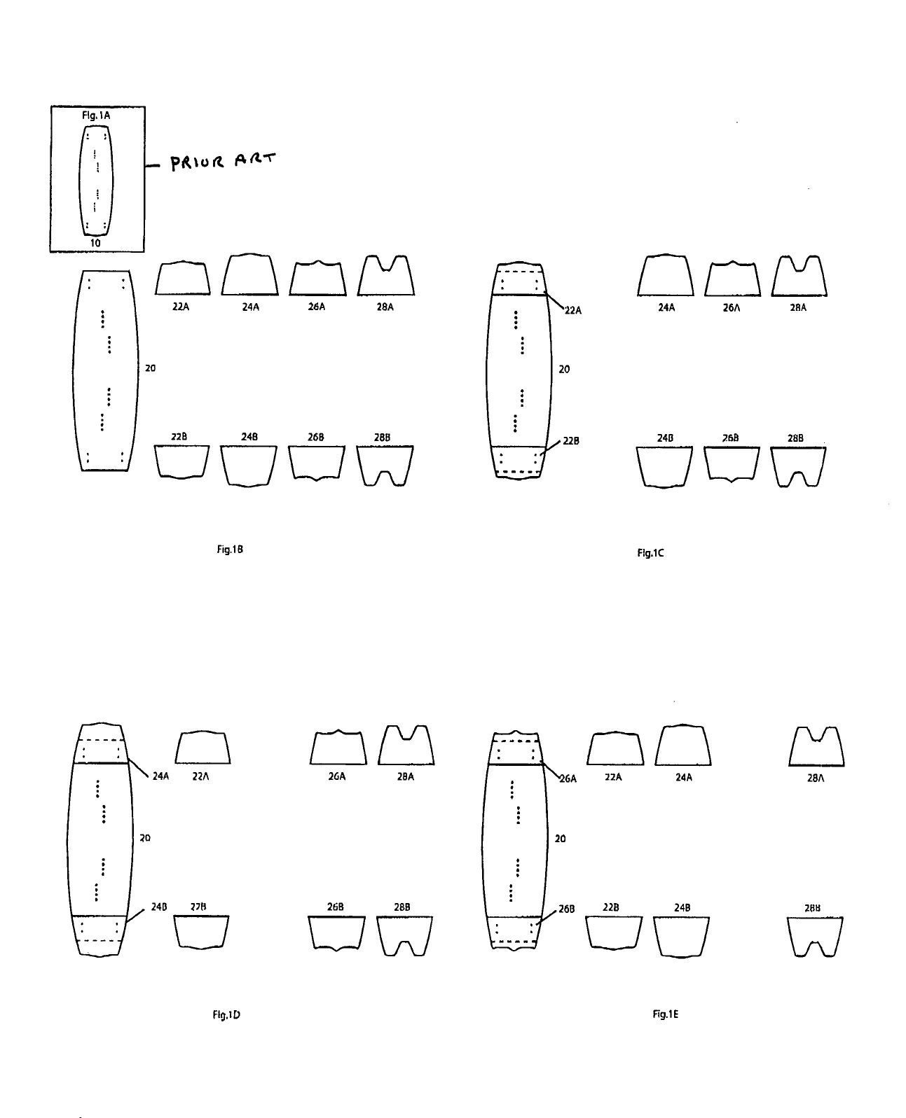

With reference now to the drawings, FIG. 1A depicts a kiteboard or wakeboard, referenced as 10, having fixed dimensions in accordance with the prior art. FIGS. 1B-1E depict a kiteboard or wakeboard in accordance with the present invention. More particularly, the present invention contemplates a base board section 20, and a plurality of interchangeable tips, 22A, 24A, 26A, and 28A, and tails, 22B, 24B, 26B, and 28B. Base board 20 comprises a main body suitable for use as a kiteboard or wake board and has a front end 20A adapted to receive one of tips 22A-28A connected thereto. Similarly base board 20 has a rear end 20B adapted to receive one of tails 22B-28B connected thereto. Tips 22A-28A and tails 22B-28B are each separately shaped or configured to provide, upon attachment, a board having different performance characteristics. FIG. 1C depicts base board 20 with tip 22A and tail 22B attached. FIG. 1D depicts base board 20 with tip 24A and tail 24B. Finally, FIG. 1E depicts base board 20 with tip 26A and tail 26B. As should be apparent, attachment of different tips and tails change the overall shape and/or performance characteristics of the platform. Attachment of the tips and tails is preferably accomplished by a mechanical fastening system that does not require the use of tools. For example, locking dowl rods may be provided for insertion within corresponding apertures in base board 20 and tip and tail sections.

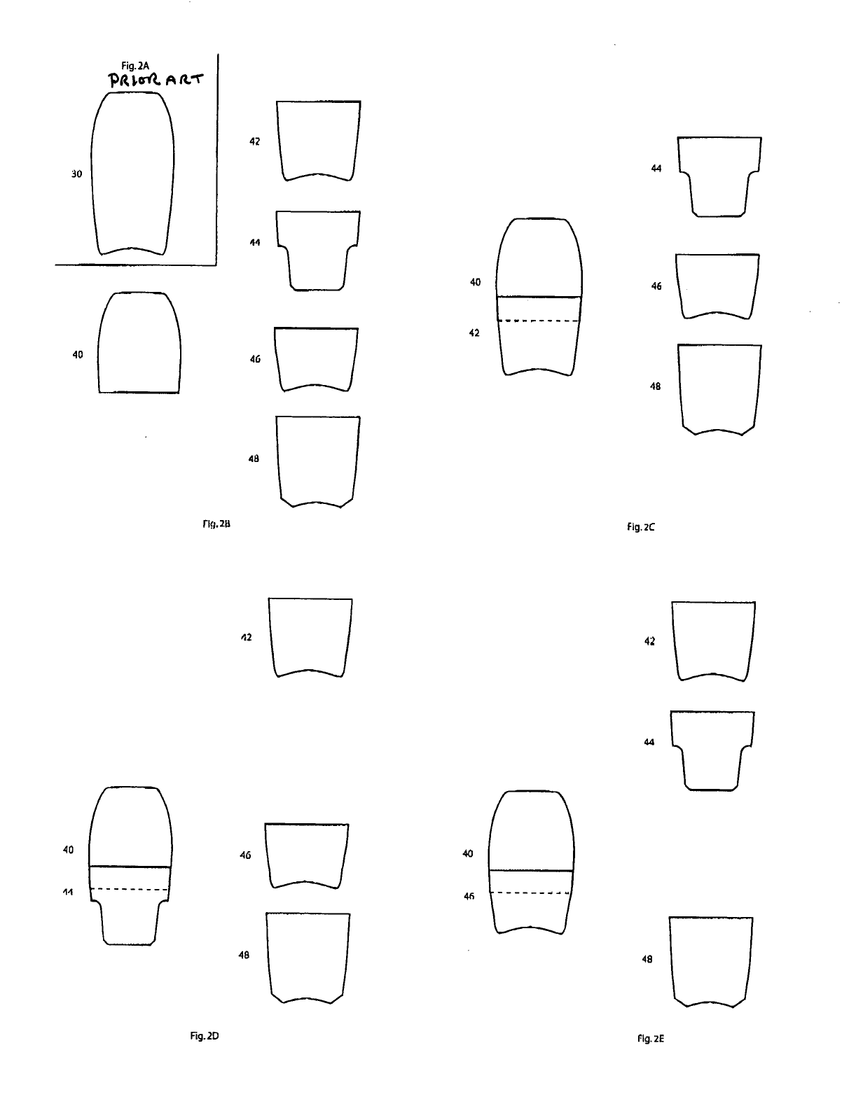

FIG. 2A depict a bodyboard, referenced as 30, in accordance with the prior art. FIG. 2B depicts a body board in accordance with the present invention comprising a base board 40, and attachable tail sections, referenced as 42-48. Tail sections 42-48 have differing shapes so as to provide the user with a selection of performance characteristics. FIG. 2C illustrates base board 40 with tail section 42 connected thereto. FIG. 2D illustrates base board 40 with tail section 44 connected thereto. FIG. 2E illustrates base board 40 with tail section 46 connected thereto. As should be apparent, tail section 48 is similarly connectable although not shown in a connected configuration. Accordingly, the user is provided a base board 40 and a selection of connectable tail sections 42-48 having differing performance characteristics that allow the user to quickly assemble a bodyboard having desired performance characteristics.

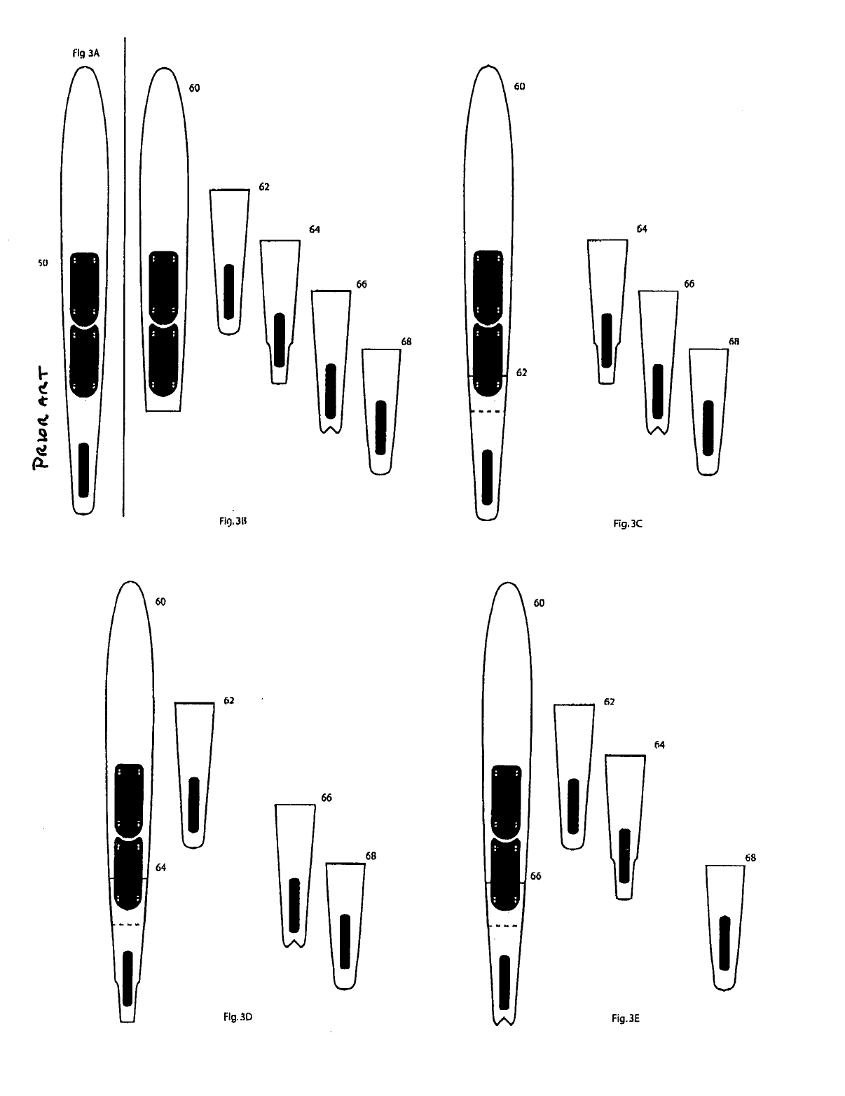

FIG. 3A depicts a water ski 50 in accordance with the prior art comprising an elongate sliding platform have an intermediate portion adapted with bindings and a tail portion adapted with a fin box. FIG. 3B depicts a water ski in accordance with the present invention comprising a base ski 60 and a plurality of attachable tail ends, referenced as 62-68. Tail ends 62-68 each have different shapes so a to provide differing performance characteristics, and may further have different fin configurations. FIG. 3C depicts base ski 60 having tail 62 connected thereto. FIG. 3D depicts base ski 60 having tail 64 connected thereto. FIG. 3D depicts base ski 60 having tail 66 connected thereto. As should be apparent, tail 68 is similarly connectable to base ski 60.

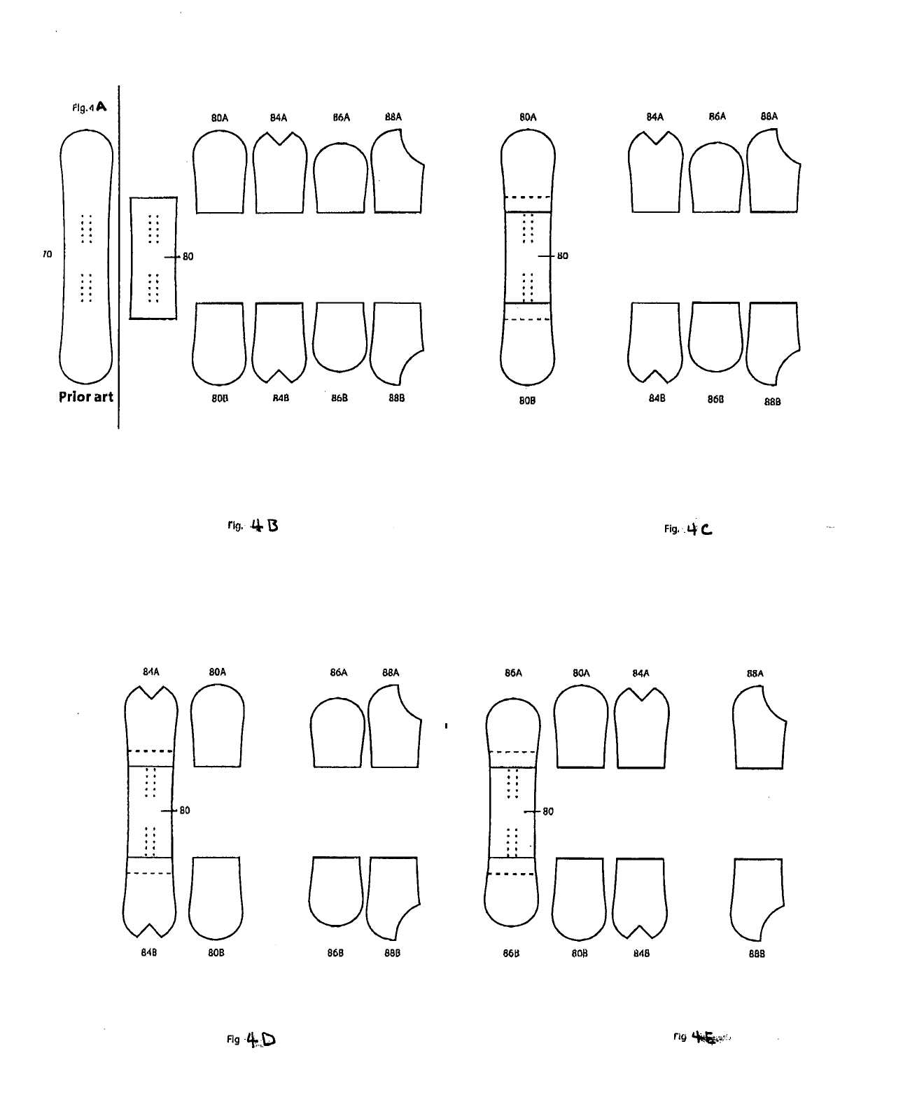

FIG. 4A depicts a snowboard 70 having fixed dimensions in accordance with the prior art. FIG. 4B depicts a snowboard in accordance with the present invention comprising a main board 80 and a plurality of interchangeable tips, referenced as 82A-88A, and tails, referenced as 82B-88B. The tips and tails have differing shapes or other performance features that allow the user to customize the board. FIG. 4C depicts main board 80 adapted with tip 82A and tail 82B. FIG. 4D depicts main board 80 adapted with tip 84A and tail 84B. Finally, FIG. 4E depicts main board 80 adapted with tip 86A and tail 86B. As should be apparent, tip 88A and tail 88B may be similarly connected to main board 80. The user may also mix and match tips and tails to provide the board with an even wider variety of performance characteristics.

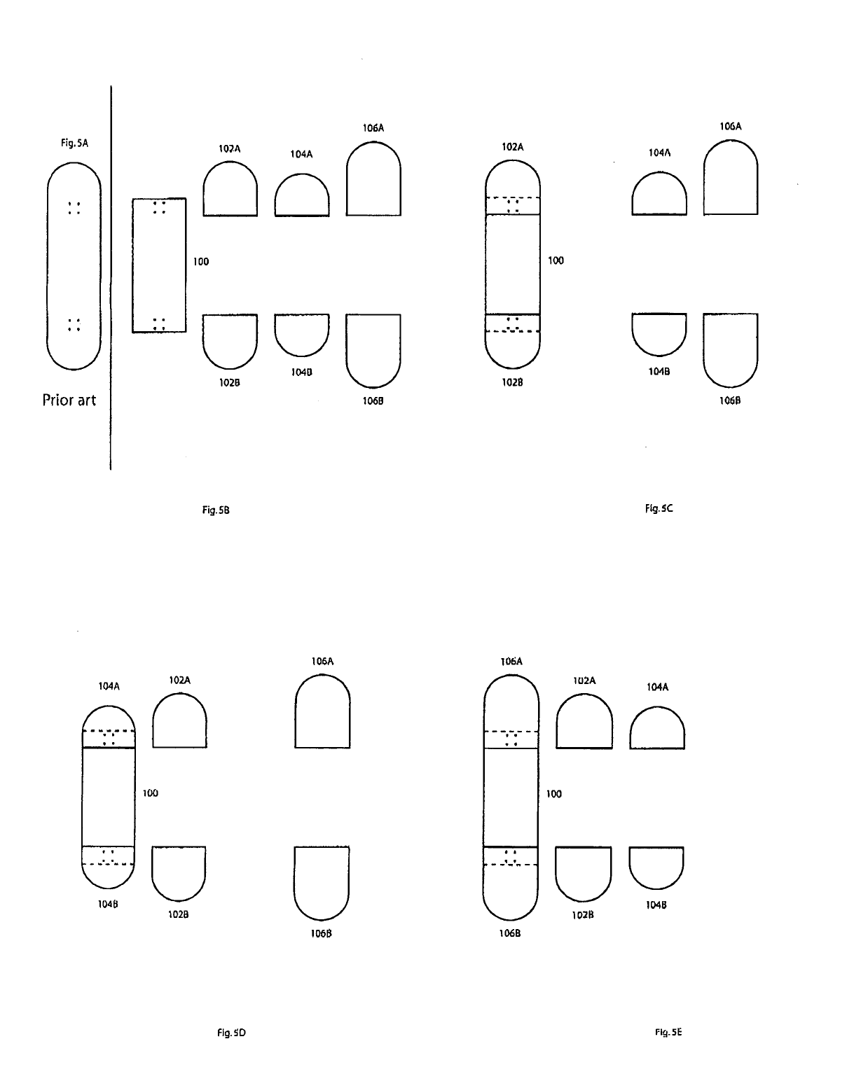

FIG. 5A depicts a skateboard 90 having fixed dimensions in accordance with the prior art. FIG. 5B depicts a skateboard in accordance with the present invention comprising a main base board 100 and a plurality of interchangeable connectable tips, referenced as 102A-106A, and tails, referenced as 102B-106B. Base board 100 has an undersurface to which is attached the rolling hardware, namely trucks, axels, and wheels. FIG. 5C depicts base board 100 adapted with tip 102A and tail 102B. FIG. 5D depicts base board 100 adapted with tip 104A and tail 104B. Finally, FIG. 5E depicts base board 100 adapted with tip 106A and tail 106B. As should be apparent, the tips and tails are of differing shapes, lengths, etc. thereby changing the overall shape, length, and performance of the skateboard.

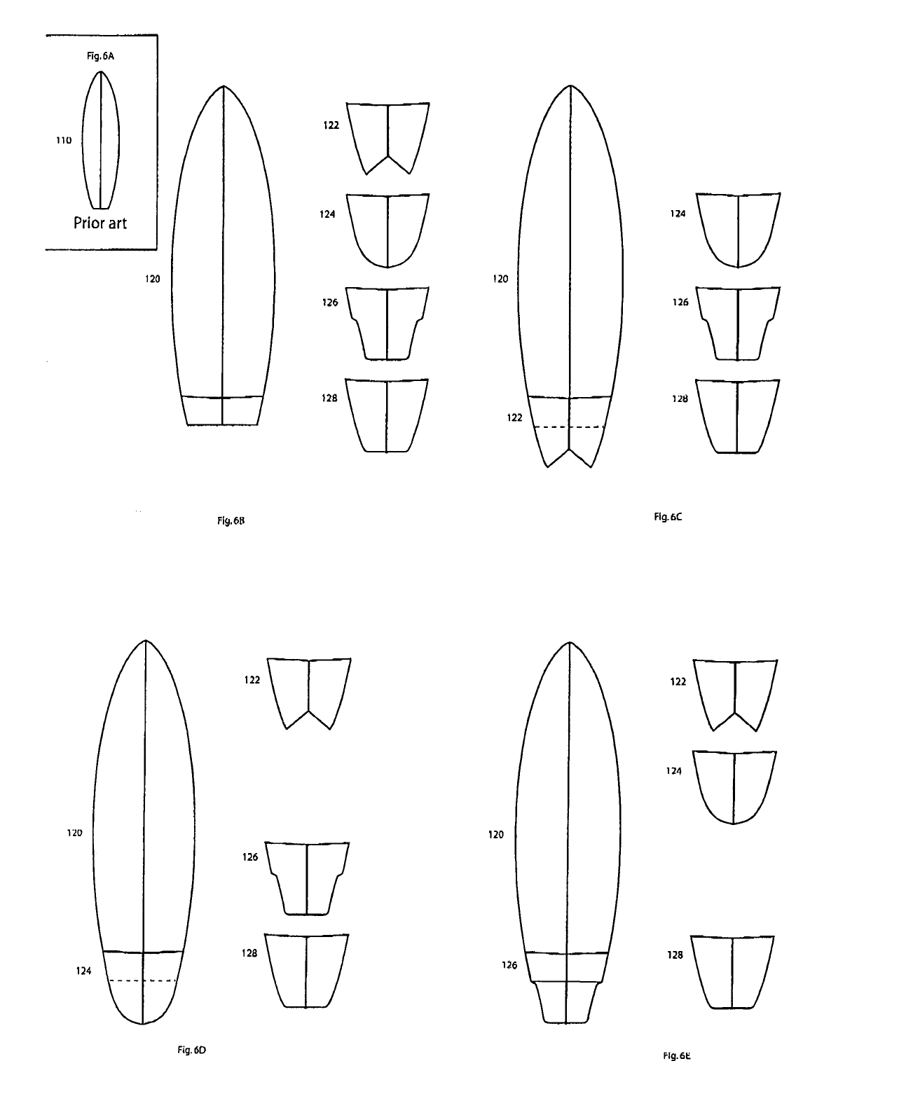

FIG. 6A depicts a surfboard 110 having a fixed shape and tail fin configuration in accordance with the prior art. FIG. 6B depicts a surfboard in accordance with the present invention comprising a main board body 120, and interchangeable tails, referenced as 122-128. The interchangeable tails preferably have different shapes, sizes, and fin configurations so as to provide different performance characteristics when attached the main board body 120. FIG. 6C depicts main body board 120 with tail 122 attached. FIG. 6D depicts main body board 120 with tail 124 attached. FIG. 6E depicts main body board 120 with tail 126 attached.

A skilled artisan will recognize from the disclosure herein, a large number of other adaptations. For example, extension or retraction may be employed with or without combinable or interchangeable parts. Moreover, platforms may be assembled from half sections, namely front have section connected to a rear half section, or alternatively left/right connectable side sections. In addition, the sides of the sliding platform may also be adapted to accept interchangeable side components, such as side edge contour and overall platform width. Furthermore, the present invention contemplates adaptations to sliding boards wherein performance aspects unrelated to size and shape are accomplished. More particularly, in an alternate embodiment the present invention contemplates adapting sliding platforms to alter characteristics primarily relating to stiffness and flexibility. According to this aspect of the present invention, sliding platforms are adapted to receive interchangeable stiffening members, disposed either longitudinally or transversely, within the platform so as to alter flexibility. The stiffening members preferably comprise elongate shafts fabricated from carbon fiber or metal of varying degrees of flexibility. By replacing a stiff member with a flexible member the overall flexibility of the platform is increased, and vice versa.

The figures show various exemplary boards and exemplary configurations and combinations meant to provide specific simplified examples but in no way meant to limit the scope of this disclosure. In contrast, an artisan will recognize from the disclosure herein, a vast number of potential adaptable shapes and configurations to create desirable differing shapes.

Although the foregoing invention has been described in terms of certain preferred embodiments, other embodiments will be apparent to those of ordinary skill in the art from the disclosure herein. Additionally, other combinations, omissions, substitutions and modifications will be apparent to the skilled artisan in view of the disclosure herein. Accordingly, the present invention is not intended to be limited by the reaction of the preferred embodiments, but is to be defined by reference to the appended claims.

The instant invention has been shown and described herein in what is considered to be the most practical and preferred embodiment. It is recognized, however, that departures may be made therefrom within the scope of the invention and that obvious modifications will occur to a person skilled in the art.

1. An adaptable recreational sliding platform comprising:
a first section; and
at least one interchangeable section removably combinable with the first section thereby changing a shape or performance characteristic of the sliding platform.

2. The platform of claim 1, further comprising another interchangeable section that when combined with the first section changes a shape or performance characteristic of the sliding platform.

3. The platform of claim 1, wherein said first section comprises a board.

4. The platform of claim 3, wherein said board is a kite board.

5. The platform of claim 3, wherein said board is a surfboard.

6. The platform of claim 1, wherein said device is a water ski.

7. The platform of claim 3, wherein said board is a skim board.

8. The platform of claim 3, wherein said board is a knee board.

9. The platform of claim 3, wherein said board is a wake board.

10. The platform of claim 3, wherein said board is a boogie board.

11. The platform of claim 1, wherein said at least one interchangeable section comprises a nose section.

12. The platform of claim 1, wherein said at least one interchangeable section comprises a tail section.

13. The platform of claim 12, wherein said at least one interchangeable section comprises a one or more fin sections.
